(19) United States
(12) Patent Application Publication
(10) Pub. No.: US 2010/0039366 A1
(43) Pub. Date: Feb. 18, 2010

(54) BACKLIGHT DISPLAY AND METHOD FOR A VEHICLE

(76) Inventor: Rody Hardy, Raymond, OH (US)

Correspondence Address: Emerson, Thomson & Bennett, LLC, 777 W. Market Street, Akron, OH, 44303, US

(21) Appl. No.: 12/193,193

(22) Filed: Aug. 18, 2008

(51) Int. Cl. G09G 3/36

(52) U.S. Cl. 345/102

(57) ABSTRACT

An opaque divider divides two independently-controllable backlights to a vehicle-based display screen. In this way light from one backlight does not interfere with the light (or the lack thereof) from the other backlight.

### I. BACKGROUND OF THE INVENTION

A. Field of Invention

This invention pertains to the art of methods and apparatuses of vehicle-based monitor screens, and more specifically, to methods and apparatuses relating to the illumination of an integrated monitor in a vehicle during night travel.

B. Description of the Related Art

It is well known to provide a vehicle equipped with display monitor. The display monitor can be programmed to control most customizable functions associated with a vehicle including, for some non-limiting examples, temperature settings for the interior of the vehicle, engine management characteristics, and suspension. Additionally, modern vehicles have navigational computers which give passengers point by point instructions to aid them in getting to their desired destination. Display monitors may also be used to convey those instructions to the passengers.

Many vehicle manufacturers provide their vehicles with display screens using liquid crystal display (LCD) technology. For example, FIG. 1 and FIG. 2 show one prior art embodiment of a display screen 11 that is mounted in a display housing 10 that is positioned on the interior dashboard 12 of a vehicle 14. The use of reduced size display monitors have allowed vehicle manufacturers to integrate displays in many different ways. Prior to affordable LCD technology, it would have been necessary to install a display that used Cathode Ray Tube (CRT) technology which requires a large amount of space and is very heavy (relative to LCD technology). While LCD technology is preferable over CRT monitors when implemented in vehicles, LCD requires a light source to render the image on the LCD screen visible to the viewer. This light-source is commonly called a “backlight”. Normally, only one backlight is required to properly illuminate the LCD screen. However, it is also known in the art to have multiple backlights illuminating a LCD screen. It is also known in the art to reduce the amount of backlighting for an integrated display screen 11 during night driving.

One drawback to integrating an LCD (or any other type of display screen) into a vehicle is the common effect of having a display screen 11 in a powered state in a dark environment but not displaying any information. This effect can be best understood by comparing it to being in a dark room with a blank television or computer screen that is in the powered or “on” state. While the display screen 11 is “blank”, it is still possible to ascertain that the display screen 11 is in a powered state. This is due to the display screen 11 still emitting light despite not displaying anything on the screen. As shown in FIG. 3, in a dark environment, the “black” area will appear as a dark gray due to the backlight of the display screen 11. This effect is due to the light emitted by the backlight and the ability of the human eye to detect the light given off by the display screen 11 (despite the screen being blank).

One known method used to minimize the light emitted by the display screen 11 during night driving is to minimize the amount of information displayed on the display screen, shown in FIG. 3. However, as discussed above, even a blank display screen emits light which may be undesired. What is needed is a way to eliminate the light emitting from the screen when the entire screen is not in use, or limit the amount of light when only a portion of the screen is being used.

### II. SUMMARY OF THE INVENTION

According to one embodiment of the present invention, a vehicle may include a vehicle frame, a locomotion source operatively supported to the frame that provides locomotion for the vehicle, and at least one passenger seat for use by an associated vehicle passenger. A backlit display screen may be operatively supported to the vehicle frame for use by the associated vehicle passenger when seated in the passenger seat. The backlit display screen assembly may include a display housing, two independently-controllable backlights positioned to illuminate the display screen in the housing, and an opaque divider separating the two backlights.

According to another embodiment of this invention, a method comprises the steps of: providing a vehicle comprising a frame, a locomotion source operatively supported to the frame that provides locomotion for the vehicle, at least one passenger seat for a vehicle passenger, and, providing a backlit display screen assembly comprising a display screen housing operatively supported to the frame, a display screen operatively connected to the display housing, an opaque divider positioned behind the display screen for dividing the display screen into a first display zone and a second display zone, a first backlight for use in illuminating the first display zone, a second backlight for use in illuminating the second display zone, wherein the first backlight is separated from the second backlight by the opaque divider, and a control mechanism for use in operating the first and second backlight for (a) operating the vehicle in low light conditions, (b) operating the control mechanism to cause the first backlight to enter an inactive state, (c) illuminating only the second viewing area via the second backlight and preventing the first display zone from receiving illumination from the second backlight.

One advantage of this invention is increasing safety to the driver and occupants of the vehicle by limiting the amount of light emitted while operating the vehicle in low light conditions.

Another advantage is the ability to customize and/or limit the amount of information displayed by the display screen assembly. This permits the driver to tailor the information to their own liking.

Yet another advantage of this invention is the elimination of any luminescent interference from one backlit screen to another. An opaque divider is implemented in order to eliminate any light emitted from an active screen that is in close proximity with an inactive screen.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a front perspective view of a vehicle that may use the display screen of this invention.

FIG. 2 is a front perspective view of a prior art display screen from the view of the driver.

FIG. 3 is a front view of the display screen shown in FIG. 2.

FIG. 4 illustrates a screen capture of a prior art display screen.

FIG. 4A is an exploded side view of the display screen shown in FIG. 3.

FIG. 5 is a front schematic view of a display screen according to one embodiment of this invention.

FIG. 6 is a side schematic view of the display screen of FIG. 5.

FIG. 7 is a side schematic view of a display with three opaque dividers.

FIG. 8 is a screen capture of the display screen according to one embodiment of this invention, shown in normal day operating mode.

FIG. 8A is a front perspective view of the display screen and housing from the view of the driver according to one embodiment of this invention shown in normal day operating mode.

FIG. 9 is a screen capture of the display screen of FIG. 8 but shown in minimum day operating mode.

FIG. 10 is a screen capture of the display screen of FIG. 8 but shown in normal night operating mode.

FIG. 11 is a screen capture of the display screen of FIG. 8 but shown in minimum night operating mode.

### IV. DETAILED DESCRIPTION OF THE INVENTION

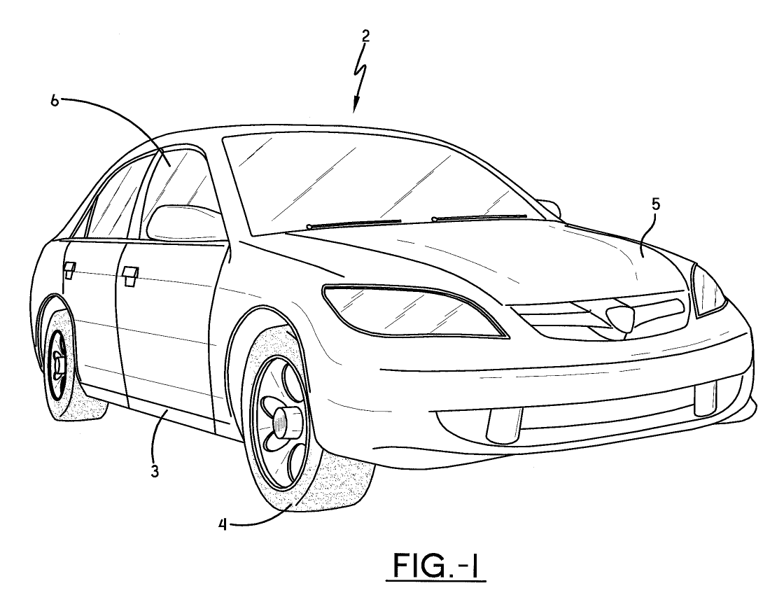

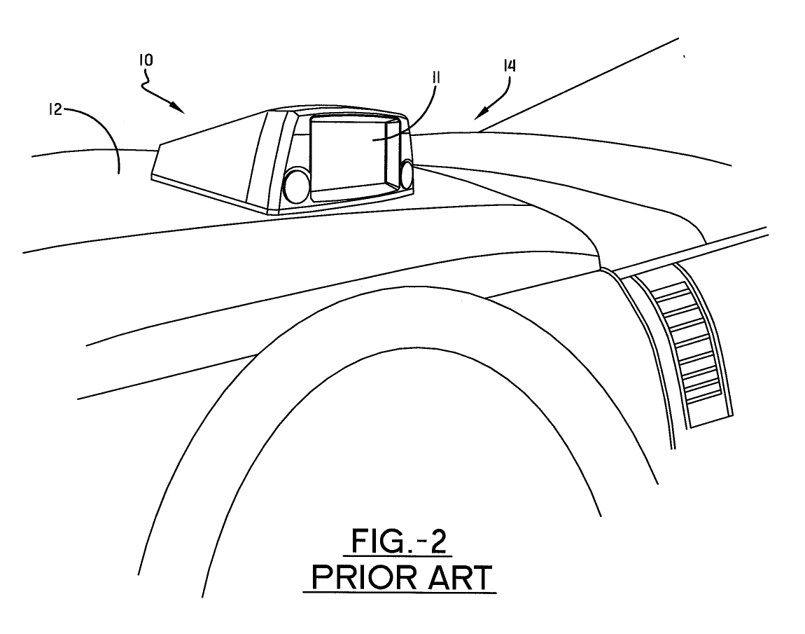

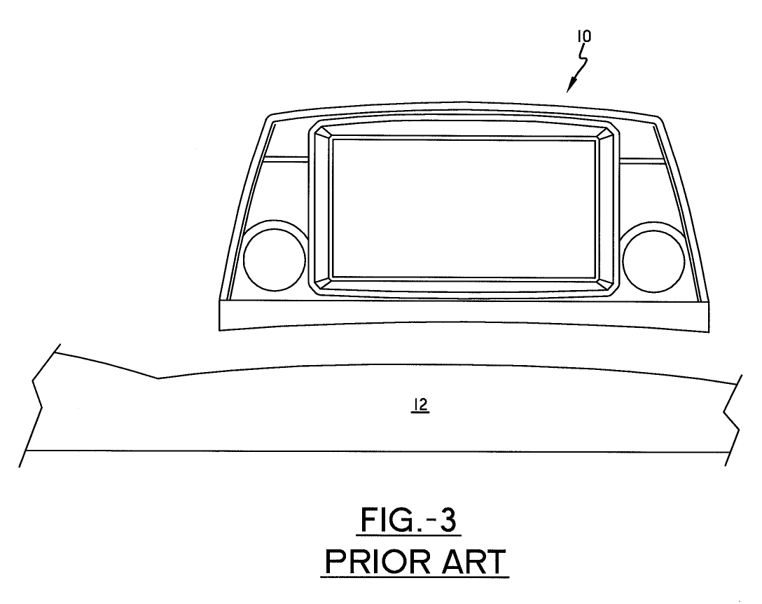

Referring now to the drawings wherein the showings are for purposes of illustrating embodiments of the invention only and not for purposes of limiting the same, and wherein like reference numerals are understood to refer to like components, FIG. 5 illustrates a display screen 28 that may be used with a vehicle, such as vehicle 2 shown in FIG. 1, according to one embodiment of this invention. While the vehicle 2 shown is an automobile, it is to be understood that the display screen 28 of this invention will work with any vehicle including, for some non-limiting examples, any modern mode of transportation or vehicle, including automobiles, trucks, motorcycles, aircraft or sea-faring vessels. The vehicle 2 may include a frame or rigid body 3, one or more ground engaging wheels 4 mounted to the frame 3, and a locomotion source 5, mounted to the frame 3, for use in providing locomotion for the vehicle. The locomotion source could be of any type chosen with the sound judgment of a person of skill in the art including, for some non-limiting examples, an internal combustion engine (ICE), an electric motor, and so called “hybrids” which combine an ICE with an electric motor.

With reference now to FIG. 1, the vehicle 2 may also include a passenger compartment 6, mounted to the frame 3, and used to house passengers during travel of the vehicle 2 as is well known. The passenger compartment 6 may include one or more passenger seats 7 and may house any number of passengers chosen with the sound judgment of a person of skill in the art. While the display screen 28 of this invention is most typically mounted within the passenger compartment 6, such as to a dashboard or interior console, it should be understood that the display screen 28 of this invention can be mounted to the vehicle 2 in any location and in any manner chosen with the sound judgment of person of skill in the art. The display screen 28 of this invention may be used to display any type or quantity of information chosen with the sound judgment of person of skill in the art.

With reference now to FIGS. 5-11, while the display screen 28 shown is of the type known as liquid crystal displays (LCD), it should be noted that the display screen 28 of this invention can be of any type including, for some non-limiting examples, cathode ray tube displays, light emitting diode displays, and plasma displays. and organic light emitting diodes. An LCD screen has the advantages of having customizable size and a thin screen depth.

With reference now to FIGS. 5-11, the number, type and style of backlight 16 used with this invention can be any chosen with the sound judgment of a person of skill in the art. Some non-limiting examples of backlights will now be briefly described. Perhaps the most widely used technology to backlight a display screen is cold cathode florescent lamps (CCFL). One example of CCFL technology is a neon lamp. However, LED backlighting is becoming more popular, most commonly used in small, inexpensive LCD panels. Another technology is electroluminescent panels (ELP). ELP backlighting is often used for larger displays or when even backlighting is important as ELP gives off uniform light over its entire surface, which is not the case in CCFL or LED based backlights. In order for a non-ELP backlight to produce even lighting (which is ideal for LCDs), the light emitted from an LCD display must originate from a backlight and be subjected to a light-focusing apparatus. Other backlight options that could be used with this invention include an organic light emitting diode (OLED), a light bulb, and an electroluminescent light source. It is to be understood that these backlight options are exemplary only. It should also be noted that the location of the backlight 16 used with this invention can be any location chosen with the sound judgment of a person of skill in the art to properly illuminate the proper portion of the display screen 28. The backlight 16, for some non-limiting examples, may be positioned to illuminate the display screen 28 from the top, the bottom, either side, or the back of the display screen 28. If multiple backlights are used, they may be positioned in any combination of locations. It is to be understood that these backlight position options are exemplary only.

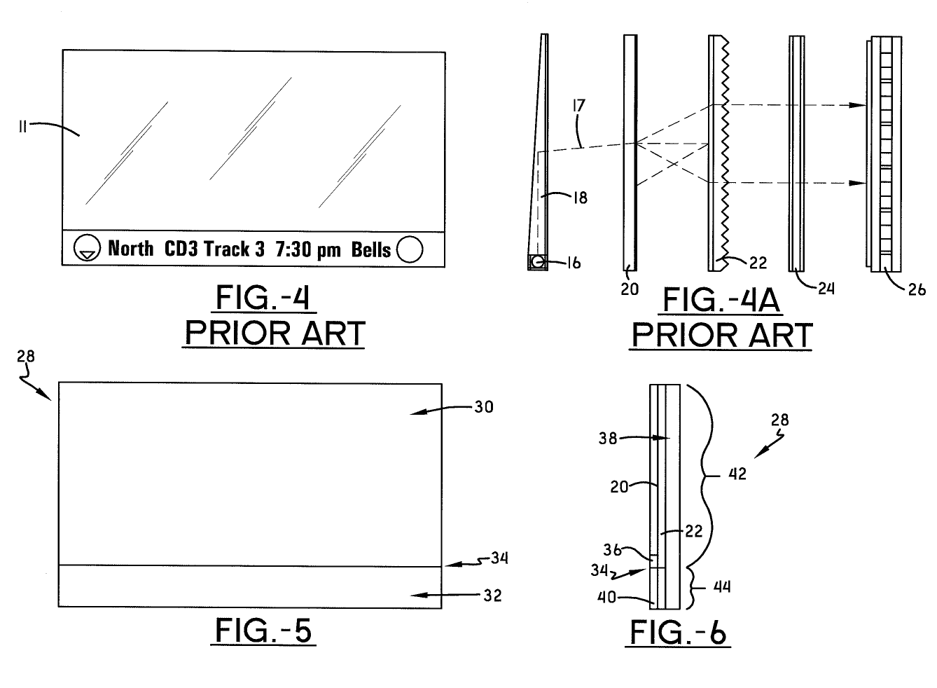

With reference now to FIG. 4A, light 17 may be produced by a backlight 16 and the light 17 may enter a light guide 18 that distributes the light evenly across the back of the LCD panel 26. At least one diffuser 20 may be placed between the light guide 18 and the backside of the LCD panel 26 to further distribute the light 17 uniformly across the display screen 11. The diffused light then travels to either side of the diffuser 20: one side contains the actual LCD panel, the other a simple reflector to guide otherwise wasted light back towards the LCD panel. After the light 17 passes through the diffuser 20 but prior to reaching the LCD panel 26, the light 17 is subjected to a prism film 24, whose function is to reject light impinging at greater than the critical angle of the prism film 22. The light 17 from the backlight 16 is thereby better distributed along the full width of the LCD panel, which eliminates bright and dark spots on the LCD panel 26. Following the prism film 22, light 17 enters a reflective polarizer 24. The reflective polarizer 24 enables more efficient use of the backlight 26, thereby increasing the brightness of LCD displays. The reflective polarizer 24 can also be used to maintain display brightness while reducing power consumption.

With reference now to FIG. 4A, while the use of a backlight 16, a light guide 18 and a diffuser 20 are generally necessary in the effective illumination of an LCD panel 26, the use of a reflective polarizer 24 and prism film 22 are not required. These display enhancement films are typically placed between the diffuser 20 and the LCD panel 26 to better optimize light 17 coming from the backlight 26. When used in combination, the prism film 22 and the reflective polarizer 24 enable a higher percentage of the light to reach the viewer, rather than being absorbed by or exiting the display at undesirable angles.

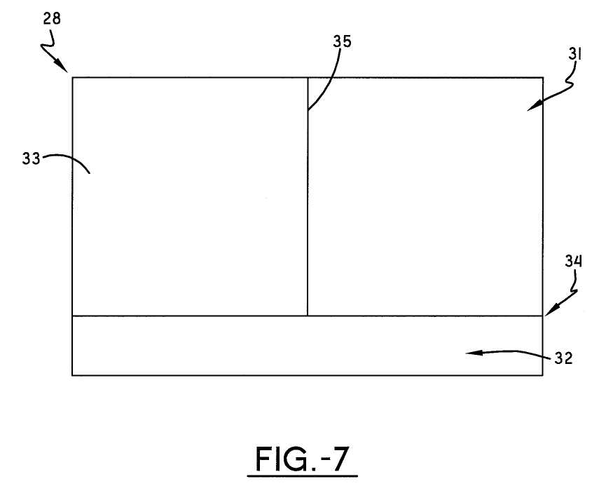

With reference now to FIGS. 5 and 7, the current embodiment display screen 28 is a multiple backlit display screen. The multiple backlit display screen 28 may include first and second display zones 30, 32 separated by an opaque divider 34. The first display zone 30 may include a first LCD portion 42 paired with a first backlight 36 while the second display zone 32 may include a second LCD display 44 paired with a second backlight 40. The multiple backlit display 28 functions identically to the displays that utilize a single backlight known in the art. However, the first and second backlights 36 and 40 can be controlled independently of the other. For example, the multiple backlit display 28 is capable of illuminating only the first display zone 30 (via the first backlight 36) while the second display zone 32 is not illuminated (with an inactive second backlight 40), or the multiple backlit display 28 can illuminate the second display zone 32 and not illuminate the first display zone 30. It should be noted that the size of the respective display zones are not meant to be limiting and are only provided as an illustrative embodiment. Additionally, it is also possible to have more than two display zones while utilizing one LCD display having a multiplicity of backlights.

With continuing reference to FIGS. 5 and 7, the independent backlighting mentioned above may be achieved with the use of the opaque divider 34. The opaque divider's 34 function is to prevent any “light leak” from one backlight to the next. Light leak is known as light from one source interfering with light (or lack thereof) from another source. Light leak can be prevented by keeping separate the illumination provided by each backlight. For example, if the first backlight 36 is illuminating the first display zone 30 while the second backlight 40 is inactive, the opaque divider 34 prevents the light from the first backlight 36 from illuminating the second display zone 32. In this way, the dark gray or partial illumination known in the prior art is eliminated.

With reference now to FIG. 7, in one embodiment the opaque divider 34 may be located between the first backlight 36 and second backlight 40 and behind the LCD display 38 and thus not visible to the viewer. The opaque divider 34 may be implemented so as to divide the display screen 28 up into equal portions such as 50% and 50%, or it may divide the display screen into unequal portions such as 60% and 40%. As a non limiting example, the opaque divider 34 may have a first display zone 30 of about 80% and a second display zone 32 comprising about 20% of the screen. However, alternative embodiments may include the use of multiple dividers with corresponding backlights. When multiple dividers are used, the location of the opaque dividers can be according to the sound judgment of a person of skill in the art. In one embodiment, the opaque divider 34 may be customizable—meaning movable according to the desire of the viewer. For example, there may be a button or selectable input near the operator so that the operator could move the opaque divider 34 to vary the size of first and second display zones 30, 32 and adjust to their personal preference.

With continuing reference to FIG. 7, an additional embodiment may include a second opaque divider 35. This opaque divider 34 may connect perpendicularly with opaque divider 34 to create a third and fourth display zone 31 and 33 respectively out of display zone 30. Correspondingly, this embodiment would also require an additional backlight (not shown) to illuminate the new display zone. As an additional embodiment, the third and fourth display zones 31, 33 can be programmed to display certain information. For example, the first display zone 30 may display audio information (CD slot number, CD track number, play time, radio station, etc., for example), the second display zone 32 could be in a non-activated state, and the third display zone 31 may be designed to show simplified driving directions. If the second display zone 32 were in an active state, the information displayed could be relaying real-time map and location information. The number of display zones and the corresponding information displayed in each zone is flexible and can be implemented and permanently set by the manufacturer or operator selected and changeable at the operator's discretion.

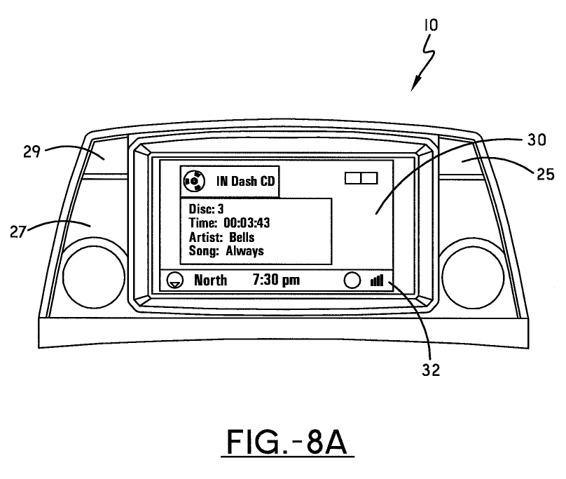

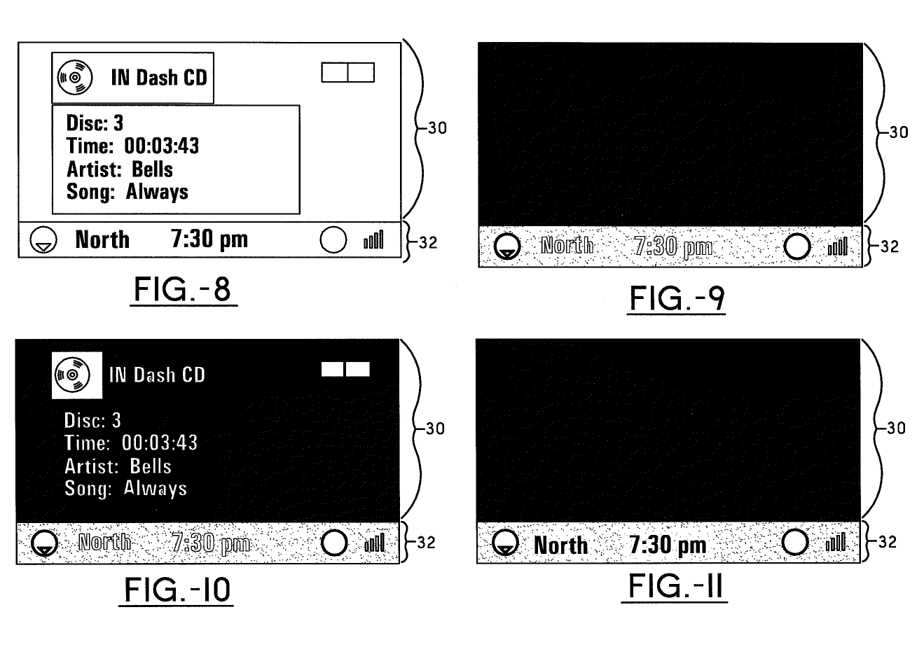

FIGS. 8-11 illustrate the different display modes that can be achieved with this invention. FIG. 8 illustrates the display mode that is commonly used during the day and set for achieving maximum brightness. The first backlight 36 is illuminating the first display zone 30 as well as the second backlight 40 is illuminating the second display zone 32. FIG. 9 illustrates the minimum display mode that is optionally used during the day and can be implemented at the desire of the viewer. The first backlight 36 is in an inactive state, with the first display zone 30 in a blank state, where the second backlight 40 is illuminating the second display zone 32. FIG. 10 illustrates the display mode that is commonly used for night driving or in low light conditions (from dusk to dawn, or when no or little sun is present) and set for achieving maximum contrast while minimizing brightness. The first backlight 36 is illuminating the first display zone 30 as well as the second backlight 40 is illuminating the second display zone 32. FIG. 11 illustrates the minimum display mode that is optionally used during night driving and can be implemented at the desire of the viewer. The first backlight 36 is in an inactive state, with the first display zone 30 in a blank state, where the second backlight 40 is illuminating the second display zone 32.

With reference to FIG. 8A, during low light conditions, in one embodiment, if the operator desires to minimize the amount of illumination emitted from the display screen 28, there may be a control mechanism 29, in the form of a button or switch 25, that may be selected. When the operator triggers the control mechanism 29, the control mechanism 29 changes the display screen 28 from resembling FIG. 4 into FIG. 11. The opaque divider 34 prevents light from the first backlight 36 from providing any illumination to the second display zone 32. In an alternative embodiment, there may be an additional display zone selector 27 and an additional opaque divider. Additionally, in another embodiment, for those vehicles that have an automated light sensor, the vehicle's computer may automatically change the display screen 28 from resembling FIG. 4 to FIG. 11 in low light conditions. This automatic transformation need not be automated, as the operator can select (within the vehicle's customizable options) if they desire the transformation to be automatic or manually operated with a button or switch 29.

Numerous embodiments have been described, hereinabove. It will be apparent to those skilled in the art that the above methods and apparatuses may incorporate changes and modification without departing from the general scope of this invention. It is intended to include all such modification and alterations in so far as they come within the scope of the appended claims or the equivalents thereof.

I/We claim:

1. A vehicle comprising:
a vehicle frame;
a locomotion source operatively supported to the frame that provides locomotion for the vehicle; and
at least one passenger seat for use by an associated vehicle passenger;
a backlit display screen assembly operatively supported to the vehicle frame and for use by the associated vehicle passenger when seated in the passenger seat, the backlit display screen assembly comprising:
(a) a display housing;
(b) a display screen;
(c) first and second independently-controllable backlights positioned to illuminate the display screen in the housing; and
(d) an opaque divider separating the at least two backlights defining a first display zone and a second display zone.

2. The vehicle of claim 1 wherein the display screen assembly further comprises:
a third independently-controllable backlight positioned to illuminate the display screen and second opaque divider dividing the display screen into a first, second and a third display zones.

3. The vehicle of claim 1 wherein the backlight comprises:
at least one cold cathode florescent lamp.

4. The vehicle of claim 1 wherein the backlight comprises:
at least one light emitting diode.

5. The vehicle of claim 1 wherein the display screen assembly comprises:
a control mechanism to operate one backlight independently of the other backlight.

6. The vehicle of claim 1 wherein the first display zone controls about 80% of the display screen, and the second display zone controls about 20% of the display screen.

7. The vehicle of claim 1 wherein the opaque divider has a horizontal orientation across the display screen.

8. The vehicle of claim 1 wherein the opaque divider has a vertical orientation across the display screen.

9. The vehicle of claim 1 wherein the first opaque divider has a horizontal orientation across the display screen and the second opaque divider has a vertical orientation across the display screen.

10. The vehicle of claim 1 wherein the first display zone controls about 40% of the display screen, and the second display zone controls about 40% of the display screen and a third display zone controls about 20% of the display screen.

11. The vehicle of claim 1 wherein the first display zone displays vehicle location information and the second display zone displays audio information.

12. The vehicle of claim 1 wherein the first display zone displays vehicle location and map information and the second display zone displays audio information and a third display zone displays guidance information.

13. The vehicle of claim 1 wherein the display screen assembly is mounted in front of an operator at the front of the vehicle.

14. The vehicle of claim 1 wherein the display screen assembly is mounted between an operator and a passenger at the front of the vehicle.

15. The vehicle of claim 1 wherein there are at least two display screen assemblies.

16. A method comprising the steps of:
providing a vehicle comprising: a frame; a locomotion source operatively supported to the frame that provides locomotion for the vehicle; at least one passenger seat for a vehicle passenger; and,
providing a backlit display screen assembly comprising: a display screen housing operatively supported to the frame, a display screen operatively connected to the display housing, an opaque divider positioned behind the display screen for dividing the display screen into a first display zone and a second display zone, a first backlight for use in illuminating the first display zone, a second backlight for use in illuminating the second display zone, wherein the first backlight is separated from the second backlight by the opaque divider, and a control mechanism for use in operating the first and second backlight;
(a) operating the vehicle in low light conditions;
(b) operating the control mechanism to cause the first backlight to enter an inactive state;
(c) illuminating only the second viewing area via the second backlight and preventing the first display zone from receiving illumination from the second backlight.

17. The method of claim 16 wherein step comprises the steps of:
operating the control mechanism to cause the first backlight to activate;
illuminating the first viewing area with the first backlight and illuminating the second viewing area with the second backlight.
